(19) United States
(12) Patent Application Publication
(10) Pub. No.: US 2022/0083654 A1
(43) Pub. Date: Mar. 17, 2022

(54) ANOMALOUS BEHAVIOR DETECTION IN A DISTRIBUTED TRANSACTIONAL DATABASE

(71) Applicant: BRITISH TELECOMMUNICATIONS PUBLIC LIMITED COMPANY, LONDON (GB)

(72) Inventor: Jonathan ROSCOE, London (GB)

(21) Appl. No.: 17/310,018

(22) PCT Filed: Dec. 18, 2019
(86) PCT No.: PCT/EP2019/085913

§ 371 Date: Jul. 9, 2021

(30) Foreign Application Priority Data
Jan. 9, 2019 (EP) 19150864.7

(51) Int. Cl. G06F 21/55; G06F 16/27

(52) U.S. Cl. CPC G06F 21/554; G06F 2221/034; G06F 16/27

(57) ABSTRACT

A computer implemented method of anomalous behavior detection of an entity transacting in a distributed transactional database, the method including: selecting a subset of features of at least a first subset of transactions in the database as a feature set; generating a statistical model of the first subset of transactions in terms of the selected features; identifying a second subset of transactions in the database including transactions related to the entity; generating an encoded representation of each transaction in the second subset of transactions based on a comparison of the selected features of the transaction with the statistical model, such that the encoded representation of at least some of the transactions in the second subset of transactions identify behavior of the entity as anomalous.

### PRIORITY CLAIM

The present application is a National Phase entry of PCT Application No. PCT/EP2019/085913, filed Dec. 18, 2019, which claims priority from EP Application No. 19150864.7, filed Jan. 9, 2019, which is hereby fully incorporated herein by reference.

### TECHNICAL FIELD

The present disclosure relates to the detection of an entity behavior in a distributed transactional database.

### BACKGROUND

Distributed transactional databases include transactions generated in respect of, and between, transacting entities. It is beneficial to detect entities transacting via such databases having, or acting under the influence of, malicious intent. For example, entities constituted as computer implemented methods operating in computer systems transacting via the database can be susceptible to malicious software, hijacking or the like. Alternatively, entities can be specifically provided to effect malicious, abusive or disruptive transactions in the database.

Thus, there is a challenge in detecting, protecting against and/or mitigating such entity behavior.

### SUMMARY

The present disclosure accordingly provides, in a first aspect, a computer implemented method of anomalous behavior detection of an entity transacting in a distributed transactional database, the method comprising: selecting a subset of features of at least a first subset of transactions in the distributed transactional database as a feature set; generating a statistical model of at least the first subset of transactions in terms of the selected subset of features; identifying a second subset of transactions in the distributed transactional database comprising transactions related to the entity; generating an encoded representation of each transaction in the second subset of transactions based on a comparison of the selected subset of features of the transaction with the statistical model, such that the encoded representation of at least one of the transactions in the second subset of transactions identify behavior of the entity as anomalous.

In some embodiments, the distributed transactional database is a blockchain data structure.

In some embodiments, the entity has associated one or more identifiers on which basis indications of the entity are stored in one or more transactions in the distributed transactional database, such one or more transactions being transactions involving the entity.

In some embodiments, the one or more identifiers are addresses associated with the entity, and each of the basis indications of the entity includes one or more of: an address for the entity; a data item derived from an address for the entity; and a signature of the entity.

In some embodiments, the data item derived from an address for the entity is generated based on a hash of an address for the entity.

In some embodiments, the one or more transactions related to the entity include one or more of: transactions including an indication of the entity; transactions occurring in a chain of transactions in the distributed transactional database at a distance from a transaction including an indication of the entity within a predetermined threshold distance; transactions occurring in a chain of transactions in the distributed transactional database satisfying one or more predetermined criteria, the one or more predetermined criteria identifying transactions leading to or arising from transactions generated by or for the entity; transactions including an identification or indication of one or more other entities determined to be under a common control with the entity.

In some embodiments, the encoded representation for each transaction in the second subset of transactions includes an indication, for each feature of the selected subset of features, of a similarity of the feature for the transaction and the statistical model in respect to the feature.

In some embodiments, the encoded representation for each transaction in the second subset of transactions is a binary representation in which a binary value is provided for each feature of the selected subset of features for the transaction in the second subset of transactions such that similarity at a threshold degree of similarity for the feature is indicated by the binary value.

In some embodiments, the selected subset of features are ordered according to a predetermined significance of each feature of the selected subset of features.

In some embodiments, the binary values in the binary representation are ordered in accordance with the ordering of the selected subset of features such that more significant features of the selected subset of features are indicated in more significant binary value positions in the binary representation, so as to provide for comparison between the encoded representations based on a magnitude of a numerical value of the encoded representations.

In some embodiments, the encoded representation for each transaction in the second subset of transactions identifies anomalous behavior based on a classifier.

In some embodiments, the classifier is trained to classify encoded representations for transactions of entities exhibiting anomalous behavior based on a supervised training process.

In some embodiments, the classifier is trained to classify encoded representations for transactions related to the entity as belonging to the entity based on historic behavior of the entity, the anomalous behavior being identified by a classification for the entity that is inconsistent with the classifications based on the historic behavior.

In some embodiments, the anomalous behavior indicates malicious interference with the entity.

In some embodiments, the method further comprises, responsive to the identification of anomalous behavior, implementing one or more of protective and remedial measures for the entity.

In some embodiments, the one or more protective measures include one or more of: preventing the generation of new transactions by the entity; preventing the generation of transactions referring to or based on transactions related to the entity; suspending the generation of transactions in the distributed transactional database; and executing security software on one or more computer systems used by the entity.

The present disclosure accordingly provides, in a second aspect, a computer system including a processor and a memory storing computer program code for the method set out above.

The present disclosure accordingly provides, in a third aspect, a computer program element comprising computer program code to, when loaded into a computer system and executed thereon, cause the computer system to perform the method set out above.

### BRIEF DESCRIPTION OF THE FIGURES

Embodiments of the present disclosure will now be described, by way of example only, with reference to the accompanying drawings, in which:

FIG. 1 is a block diagram of a computer system suitable for the operation of embodiments of the present disclosure.

FIG. 2 is a component diagram of an arrangement for detecting anomalous behavior of an entity transacting in a distributed transactional database in accordance with embodiments of the present disclosure.

FIG. 3 is a flowchart of a method of anomalous behavior detection in accordance with embodiments of the present disclosure.

### DETAILED DESCRIPTION

Sequential transactional databases are increasingly used to provide records of transactions occurring between entities such as computer systems or digital representations of physical entities such as users. For example, a blockchain database or data structure is a sequential transactional database that may be distributed and is communicatively connected to a network. Such transactional databases are well known in the field of cryptocurrencies and are documented, for example, in “Mastering Bitcoin. Unlocking Digital Crypto-Currencies.” (Andreas M. Antonopoulos, O'Reilly Media, April 2014). For convenience, such a database is herein referred to as a distributed transactional database though other suitable databases, data structures or mechanisms possessing the characteristics of a distributed transactional database, such as a blockchain, can be treated similarly. A distributed transactional database provides a distributed chain of data structures (commonly known as blocks) accessed by a network of nodes known as a network of miners. Each block in the database includes one or more transaction data structures. In some distributed transactional databases, such as the BitCoin blockchain, the database includes a Merkle tree of hash or digest values for transactions included in a block to arrive at a hash value for the block, which is itself combined with a hash value for a preceding block to generate a chain of blocks (blockchain). A new block of transactions is added to the database by miner software, hardware, firmware or combination components in the miner network. Miners are communicatively connected to sources of transactions and access or copy the database. A miner undertakes validation of a substantive content of a transaction (such as criteria and/or executable code included therein) and adds a block of new transactions to the database when, for example, a challenge is satisfied, typically such challenge involving a combination hash or digest for a prospective new block and a preceding block in the database and some challenge criterion. Thus, miners in the miner network may each generate prospective new blocks for addition to the database. Where a miner satisfies or solves the challenge and validates the transactions in a prospective new block, such new block is added to the database. Accordingly, the database provides a distributed mechanism for reliably verifying a data entity such as an entity constituting or representing the potential to consume a resource.

While the detailed operation of distributed transactional databases and the function of miners in the miner network is beyond the scope of this specification, the manner in which the database and network of miners operate is intended to ensure that only valid transactions are added within blocks to the database in a manner that is persistent within the database. Transactions added erroneously or maliciously should not be verifiable by other miners in the network and should not persist in the database. This attribute of distributed transactional database is exploited by applications of such databases and miner networks such as cryptocurrency systems in which currency amounts are expendable in a reliable, auditable, verifiable way without repudiation. For example, blockchains can be employed to provide certainty that a value of cryptocurrency is spent only once and double spending does not occur (that is spending the same cryptocurrency twice).

Challenges exist in respect of entities transacting via a distributed transactional database. Such entities can include the miners and additionally entities employing the blockchain to transact with other entities. Entities can include users, computer systems and combinations thereof and are susceptible to attack, malicious interference or can be provided for malicious purposes from the outset. For example, a data breach providing a malicious actor with access to credentials of a transacting entity can lead to malicious transactions being generated by the entity that are not in-keeping with the entities normal behavior. Malicious interference with a computer system controlling or representing an entity, such as malware, viruses, intrusion or the like, can similarly result in atypical behavior of the entity in respect of the distributed transactional database.

### DETAILED DESCRIPTION OF EMBODIMENTS

Embodiments of the present disclosure detect anomalous behavior of an entity transacting in a distributed transactional database based on a statistical model of behavior in the database as described in detail below.

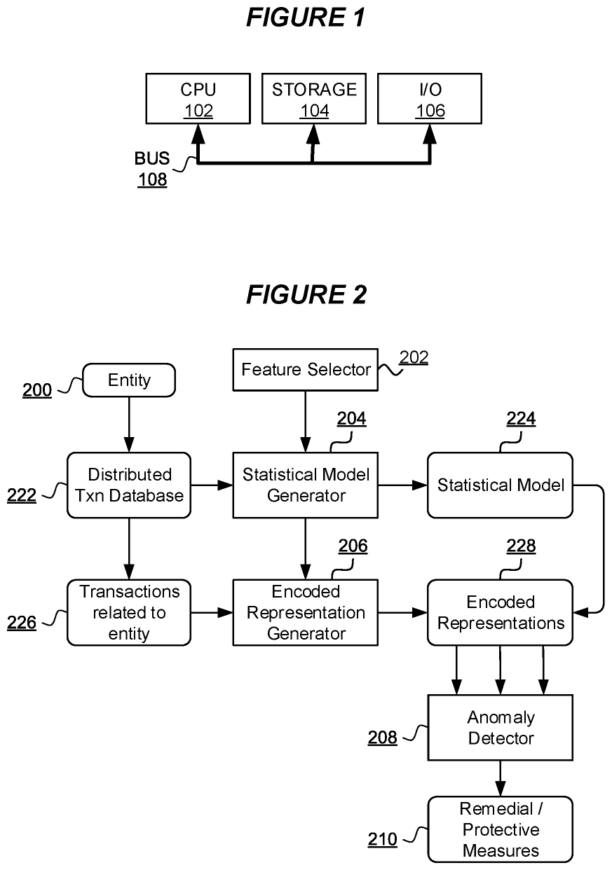

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for detecting anomalous behavior of an entity 200 transacting in a distributed transactional database 222 in accordance with embodiments of the present disclosure. The entity 200 transacts via the database 222 using hardware, software, firmware or combination facilities suitable for the accessing the database 222 and generating transactions for storage in the database 222. For example, the database 222 is a blockchain database. Thus, one or more transactions 226 related to the entity 200 are stored in the database 222.

The entity 200 has associated one or more identifiers for use in transacting via the database 222. For example, the entity 200 has associated one or more addresses such as blockchain addresses for transacting with other entities via the database 222. Transactions generated by or for the entity in the database 222 include an indication of at least one such identifier for the entity 200. For example, a transaction in which a quantity of resource is transferred to the entity 200 as beneficiary of the transaction can include an indication of the entity 200 by way of an address of the entity 200. Similarly, a transaction in which a quantity of resource is transferred by the entity 200 as originator of the resource in favor of another entity, such transaction includes an indication of entity 200 by way of a reference to a prior transaction in a chain of transactions, such prior transaction indicating the entity 200 by way of an address of the entity 200.

Notably, indications of the entity 200 need not include an identification of the entity 200 per se, such that an address associated with the entity 200 may not be used as an indication of the entity. For example, a data item derived from an address of the entity or a signature of the entity using a public/private key encryption scheme may alternatively be provided. Yet further, a data item derived from a public key may alternatively be provided. For example, in some blockchain transactions, a base58 representation of a multiply hashed identifier (such as a public key or address) with a pre-pended prefix and appended checksum can be used to indicate the entity 200.

The entity 200 can be explicitly a subject of transactions in the database 222, such as an owner of resource or beneficiary of resource in a transaction. Such transactions will include an indication of the entity 200 and are transactions related to the entity 226. Additionally, other transactions can also be related to the entity 200. For example, transactions occurring in a chain of transactions in the database 222 at a distance from a transaction including an indication of the entity 200 within a predetermined threshold distance. Such a distance can be defined, for example, in terms of a number of transactions from the transaction including an indication of the entity 200. In this way, transactions occurring a number of transactions (i.e. a distance) before or after a transaction indicating the entity 200 can additionally or alternatively be determined to be transactions related to the entity 226.

Furthermore, in some embodiments, transactions including an identification or indication of one or more other entities determined to be under a common control with the entity 200 can also be considered to be transactions related to the entity 226. Such common control can include, for example, a common entity constituted as a plurality of entities, or a plurality of computer systems each constituting an entity and all executing under common control of a singular entity.

A feature selector 202 is provided as a hardware, software, firmware or combination component for selecting a subset of features of at least some of the transactions in the database 222. The selected features thus constitute a feature set. Features of transactions can include some or all of, inter alia: transaction size; a number of inputs for a transaction; a number of outputs for a transaction; a value of a transaction (such as an amount of resource transacted, such as a cryptocurrency amount); a ratio of a value of a transaction to an amount of resource received by the entity 200 as a result of the transaction; a number of transactions; a count of a number of sequences of transactions involving the entity 200 and a number of different transacting entities where the other transacting entities have also transacted between themselves (known as a “triangle” of entities); a ratio of value input to a transaction and expended by the transaction; a transaction frequency; a ratio of value received to value sent in a transaction; an age of a resource such as a cryptocurrency resource transacted (such as an age since a cryptocurrency resource was mined); a function of a value of a transaction such as a number of “coin days” as a product of a value of a transaction and a number of days since the resource were last used in a transaction; and an indication of a use of one-time identifier for an entity such as a single-use address. It will be appreciated that such features are purely exemplary and other features of transactions in the database 222 will be apparent to those skilled in the art.

A subset of features is selected by the feature selector 202 to constitute a promising set of features for the identification of anomalous behavior by the entity 200. In one embodiment, the feature selection is performed based on a supervised machine learning algorithm in which labelled training data corresponding to database transactions and the presence of anomalous behavior by a transacting entity are used to train, for example, a classifier in order to classify features as useful in indicating such anomalous behavior. For example, a gradient descent algorithm for clustering of features with a heuristic function for scatter separability can be employed. In some embodiments the algorithm also evaluates an optimal number of clusters and reduces a distance between pairs in a cluster and maximizes a distance between clusters.

A statistical model generator 204 is further provided as a hardware, software, firmware or combination component for generating a statistical model 224 of at least a subset of transactions in the database 222 in terms of the features selected by the feature selector 202. In some embodiments, the statistical model generator 204 operates on the basis of at least a subset of all transactions in the database 222, irrespective of their relationship to the entity 226, so as to model the database 222.

In one example, the statistical model 224 provides one or more statistical measures for each feature in the feature set. For example, an average and standard deviation of a value for each feature can be generated by the statistical model generator 204.

Subsequently, an encoded representation generator 206 generates an encoded representation 228 of each of at least a subset of the transactions related to the entity 226. Each encoded representation 228 is generated based on a comparison of the selected features in a transaction related to the entity 226 and the statistical model 224. In one embodiment, an encoded representation 228 for a transaction 226 related to the entity 200 includes an indication, for each of the selected features, of a similarity of the feature for the transaction 226 and the statistical model 224 in respect of the feature. In an embodiment, the encoded representation 228 is a binary representation in which a binary value is provided for each of the selected features for the transaction 226 such that a similarity at a threshold degree of similarity is indicated by the binary value.

By way of example, the table below illustrates an exemplary statistical model 224 for feature set f₀. . . f₃, with an average and standard deviation being indicated for each feature in the feature set:

Statistical Model

| f₀ | | f₁ | | f₂ | | f₃ | |
|---|---|---|---|---|---|---|---|
| | Std. | | Std. | | Std. | | Std. |
| Avg. | dev. | Avg. | dev. | Avg. | dev. | Avg. | dev. |
| 56421 | 1000 | 112 | 10 | 10 | 1 | 8546 | 20 |

The table below illustrates an exemplary encoded representation 228 for a transaction related to the entity 226 in which a binary encoding value of “1” is recorded if a value for a transaction feature is beyond the standard deviation from the average in the statistical model for that feature, otherwise the binary encoding value of “0” is recorded:

| | Transaction Related to the Entity | | | | |
|---|---|---|---|---|---|
| | f₀ | f₁ | f₃ | f₄ | |
| Transaction Value | 20000 | 110 | 15 | 8540 | |
| Binary Encoding | 1 | 0 | 1 | 0 | Decimal 10 |

In alternative embodiments, a ternary encoding is employed representing below, above or average values for a feature in a transaction 226.

In an embodiment, the feature set is ordered so as to emphasize features at one end of the ordered list of features in the set. For example, ordering the features such that more significant features are encoded first can be employed to provide that more significant digits in, for example, a binary encoding represent features deemed more significant. Accordingly, a magnitude of a numerical (e.g. decimal) representation of the binary encoding can be used as a suitable comparator of encoded representations 228. Thus, binary values in the binary representations 228 can be ordered in accordance with the ordering of the selected features in the feature set in order that more significant features are indicated in more significant binary value positions in the binary representation, so as to provide for comparison between encoded representations 228 based on a magnitude of a numerical value of the encoded representations.

An anomaly detector 208 is provided as a hardware, software, firmware or combination component for identifying anomalous behavior of the entity 200 based on one or more of the encoded representations 228. For example, the anomaly detector 208 can identify anomalous behavior of the entity 200 based on changes to encoded representations 228 over time, such as a deviation from a determined normal range of encoded representations 228 over time. Additionally, or alternatively, the anomaly detector 208 can detect anomalous behavior of the entity 200 with reference to encoded representations of known anomalous entities, such as encoded representations generated during a test, learning or trial phase of operation of one or more entities in which at least one entity operates in a known anomalous manner. Such an anomalous entity can, for example, be an entity which is subject to malicious intervention or under malicious control, or the like.

In one embodiment, the anomaly detector 208 identifies anomalous behavior based on a classifier. Such a classifier can include, for example, inter alia: one or more perceptrons; a naive Bayes classifier; a decision tree classifier; a logistic regression algorithm; a K-nearest neighbor (KNN) algorithm; an artificial neural networks classifier; and a support vector machine. For example, a classifier can be trained to classify encoded representations 228 for transactions of entities exhibiting anomalous behavior based on a supervised training process. Additionally, or alternatively, the classifier can be trained to classify encoded representations 228 for transactions related to the entity 226 as belonging to the entity 200 based on historic behavior of the entity 200. In such an embodiment, anomalous behavior can be identified by a classification of transactions relating to the entity 228 that are inconsistent with classifications based on the historic behavior.

Thus, embodiments of the present disclosure are suitable for the identification of anomalous behavior of the entity 200 in respect of transactions in the database 222. Responsive to such identification of anomalous behavior, remedial and/or protective measures 210 can be taken. Such measures can include, for example, inter alia: preventing the generation of new transactions by the entity 200; preventing the generation of transactions referring to or based on transactions related to the entity 200; suspending the generation of transactions in the database 222; and executing security software on one or more computer systems used by the entity 200.

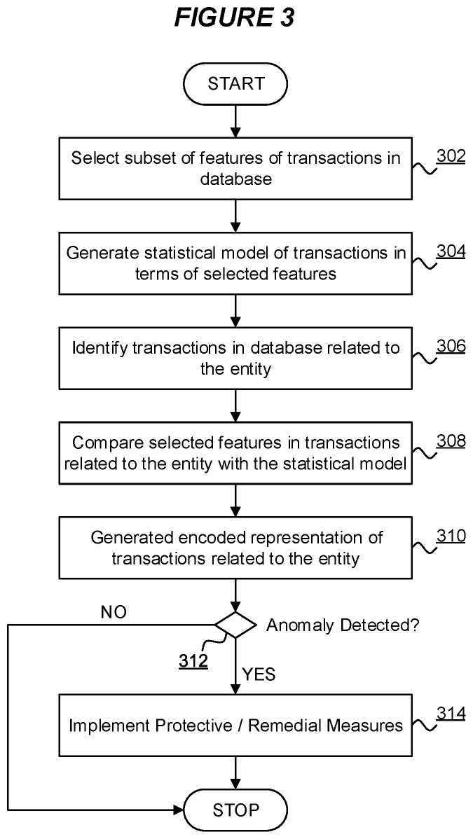

FIG. 3 is a flowchart of a method of anomalous behavior detection in accordance with embodiments of the present disclosure. Initially, at 302, a subset of features of transactions in the database 222 is selected as a feature set. At 304 the statistical model 224 of at least a subset of all transactions in the database 222 is generated. At 306 transactions related to the entity 226 are identified. At 308, features in the selected feature set are compared with features in transactions related to the entity 226 to generate an encoded representation at 310. At 312 anomalies are detected and protective and/or remedial measures are implemented at 314.

Ordered binary digits used to constitute the encoded representations 228 can be considered a measure of significance of each feature, and a decimal representation of each encoded representation 228 can be used to categorize transactions. If encoded representations were generated for all transactions in the database 222, a multimodal distribution of decimal values might be realized. This can be the case even for a subset of transactions spanning a multitude of entities (i.e. not limited to transactions related to the entity 200). Most common decimal values in such encoded representations can be used to represent common categories of behavior of entities transacting via the database 222 and transactions with uncommon decimal values indicating more unusual (less common) patterns of behavior. A degree of prevalence (or normality, commonness or uniqueness) of a transaction can be characterized by taking a prior probability of its decimal value encoded representation based on all decimal values evaluated for the database 222.

Further, classifiers can determine, for example, encoded representation decimal values (or other representations of such values) for classes of entity based on, for example, machine learning techniques. Such classes can be labelled where sufficient prior knowledge of entities used to define such classes is available.

The table below defines, by way of example only, an ordered feature set {f₀, . . . f₇} in which earlier features are prioritized as more significant. An exemplary description of each feature and a suggestion of what each feature might indicate is also provided:

| Feature | Feature | | Feature |
|---|---|---|---|
| Label | ID | Description | indicative of: |
| output/ | f₀ | Average of the input/output | Distribution |
| received | | received ratio. A higher number | of resource |
| ratio | | of outputs indicates the recipient | |
| | | is one of many. | |
| input | f₁ | Indicates an amount of available | Stockpiling |
| value/ | | resource that have been expended. | behavior |
| spent | | This may indicate stockpiling or | |
| value | | saving behavior as well as an | |
| ratio | | activity level of an entity. | |
| transaction | f₂ | Identifiers of entities such as | Size, |
| count | | addresses are often used in a | popularity, |
| | | disposable manner so transaction | social |
| | | count for an identifier may be low. | significance |
| transaction | f₃ | Indicates a level of activity. Can be | Level of |
| frequency | | used to differentiate between | Activity |
| | | humans and highly automated | |
| | | systems. | |
| average | f₄ | Large systems often batch | Distribution |
| size | | transactions resulting in larger | or |
| | | transactions. Individuals often only | aggregation |
| | | send to/from a small number of | |
| | | addresses. | |
| average | f₅ | Different systems employ different | Casual |
| fee | | estimator tools and patterns, so | versus |
| | | average fee (expended resource | commercial |
| | | rewarded to, for example, miners) | entity |
| | | can indicate method used. | |
| | | Individuals will normally favor a | |
| | | lower fee. | |
| received/ | f₆ | Distinguishes between a pattern of | Spending |
| sent output | | “loading” used by consumers and | versus |
| ratio | | load/distribution used by pools. | earning |
| | | | resource |
| average coin | f₇ | Indicates how long a resource has | Distance to |
| age | | been in circulation. Assists in | miner |
| | | differentiating mining activity. | |

Exemplary classes of entity based on the above features can include, inter alia:

| Class | Description | f₀ | f₀ | f₀ | f₀ | f₀ | f₀ | f₀ | f₀ | Decimal |
|---|---|---|---|---|---|---|---|---|---|---|
| Mining | Receive large numbers of | 0 | 1 | 1 | 1 | 1 | 0 | 1 | 0 | 122 |
| Pool | transactions with regular | | | | | | | | | |
| | frequency all of similar size. In | | | | | | | | | |
| | Bitcoin, earnings can only be | | | | | | | | | |
| | spent after 100 blocks and it is | | | | | | | | | |
| | common for block rewards to | | | | | | | | | |
| | be consolidated. | | | | | | | | | |
| Mining | An address used to pay a pool | 0 | 1 | 1 | 1 | 1 | 0 | 1 | 0 | 122 |
| Pool Hot | of miners, often not the same as | | | | | | | | | |
| Wallet | that used for the coinbase | | | | | | | | | |
| | transaction. | | | | | | | | | |
| Miner | An individual who will receive | 1 | 0 | 1 | 1 | 0 | 1 | 0 | 1 | 181 |
| | regular payments, a fraction of | | | | | | | | | |
| | the size of the block reward. | | | | | | | | | |
| Sweeper | An individual consolidating | 1 | 0 | 0 | 0 | 0 | 1 | 0 | 1 | 133 |
| | funds to avoid dust issues (dust | | | | | | | | | |
| | being very small resource | | | | | | | | | |
| | quantities discouraged by | | | | | | | | | |
| | additional fees). | | | | | | | | | |
| Tumbler | Money laundering system. | 0 | 1 | 0 | 1 | 1 | 1 | 1 | 1 | 95 |
| Typical | Having a quantity of resource | 0 | 1 | 0 | 0 | 0 | 0 | 0 | 1 | 65 |
| User | and transacting on a smaller | | | | | | | | | |
| | number of occasions. | | | | | | | | | |

To arrive at such class definitions, encoded representations are generated for a wide variety of transactions in the database, not simply those related to the entity 200. As can be seen from the above tables, a decimal representation of an encoding based on an ordered feature set can be used as an attribute for further analysis. Given prior knowledge it is possible to associate such decimal values with specific categories of activity (e.g. mining, distribution, tumbling, etc). It might be expected that a well-selected feature set would result in a multimodal distribution of decimal encoded values, so constituting a promising basis for class definition. A transaction's uniqueness can be calculated by taking a prior probability of its decimal value based on all decimal values in the network.

A distribution of decimal representations of all (or a representative subset of) transactions in a database 222 can be used to derive information identifying typical and atypical behavior of entities. Sudden changes in a distribution of decimal values may indicate a shift in behavior. If performed on a memory pool of pending (e.g. pre-committed, or awaiting processing) transactions, such a change in behavior could anticipate the effects of malicious activity arising from, for example, new ransomware or blockchain attacks.

Insofar as embodiments described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of anomalous behavior detection of an entity transacting in a distributed transactional database, the method comprising:
selecting a subset of features of at least a first subset of transactions in the distributed transactional database as a feature set;
generating a statistical model of at least the first subset of transactions in terms of the selected subset of features;
identifying a second subset of transactions in the distributed transactional database comprising transactions related to the entity;
generating an encoded representation of each transaction in the second subset of transactions based on a comparison of the selected subset of features of the transaction with the statistical model, such that the encoded representation of at least one of the transactions in the second subset of transactions identify behavior of the entity as anomalous.

2. The method of claim 1 wherein the distributed transactional database is a blockchain data structure.

3. The method of claim 1 wherein the entity has associated one or more identifiers on which basis indications of the entity are stored in one or more transactions in the distributed transactional database, such one or more transactions being transactions involving the entity.

4. The method of claim 3 wherein the one or more identifiers are addresses associated with the entity, and each of the basis indications of the entity includes one or more of: an address for the entity; a data item derived from an address for the entity; and a signature of the entity.

5. The method of claim 4 wherein the data item derived from an address for the entity is generated based on a hash of an address for the entity.

6. The method of claim 3 wherein the one or more transactions related to the entity include one or more of: transactions including an indication of the entity; transactions occurring in a chain of transactions in the distributed transactional database at a distance from a transaction including an indication of the entity within a predetermined threshold distance; transactions occurring in a chain of transactions in the distributed transactional database satisfying one or more predetermined criteria, the one or more predetermined criteria identifying transactions leading to or arising from transactions generated by or for the entity; transactions including an identification or indication of one or more other entities determined to be under a common control with the entity.

7. The method of claim 1 wherein the encoded representation for each transaction in the second subset of transactions includes an indication, for each feature of the selected subset of features, of a similarity of the feature for the transaction and the statistical model in respect to the feature.

8. The method of claim 7 wherein the encoded representation for each transaction in the second subset of transactions is a binary representation in which a binary value is provided for each feature of the selected subset of features for the transaction in the second subset of transactions such that similarity at a threshold degree of similarity for the feature is indicated by the binary value.

9. The method of claim 8 wherein the selected subset of features are ordered according to a predetermined significance of each feature of the selected subset of features.

10. The method of claim 9 wherein the binary values in the binary representation are ordered in accordance with the ordering of the selected subset of features such that more significant features of the selected subset of features are indicated in more significant binary value positions in the binary representation, so as to provide for comparison between the encoded representations based on a magnitude of a numerical value of the encoded representations.

11. The method of claim 1 wherein the encoded representation for each transaction in the second subset of transactions identifies anomalous behavior based on a classifier.

12. The method of claim 11 wherein the classifier is trained to classify encoded representations for transactions of entities exhibiting anomalous behavior based on a supervised training process.

13. The method of claim 11 wherein the classifier is trained to classify encoded representations for transactions related to the entity as belonging to the entity based on historic behavior of the entity, the anomalous behavior being identified by a classification for the entity that is inconsistent with the classifications based on the historic behavior.

14. The method of claim 1 wherein the anomalous behavior indicates malicious interference with the entity.

15. The method of claim 1 further comprising, responsive to the identification of anomalous behavior, implementing one or more of protective and remedial measures for the entity.

16. The method of claim 15 wherein the one or more protective measures include one or more of: preventing the generation of new transactions by the entity; preventing the generation of transactions referring to or based on transactions related to the entity; suspending the generation of transactions in the distributed transactional database; and executing security software on one or more computer systems used by the entity.

17. A computer system including a processor and a memory storing computer program code for performing the steps of the method of claim 1.

18. A computer program element comprising computer program code to, when loaded into a computer system and executed thereon, cause the computer system to perform the steps of the method of claim 1.
